(19) United States
(12) Patent Application Publication
(10) Pub. No.: US 2018/0079938 A1
(43) Pub. Date: Mar. 22, 2018

(54) RESOL TYPE MODIFIED PHENOL RESIN COMPOSITION, METHOD FOR PRODUCING THE SAME, AND ADHESIVE

(71) Applicant: SUMITOMO BAKELITE CO., LTD., Tokyo (JP)

(72) Inventor: Hajime Mifuka, Fujieda-shi (JP)

(73) Assignee: SUMITOMO BAKELITE CO., LTD., Tokyo (JP)

(21) Appl. No.: 15/562,595

(22) PCT Filed: Mar. 31, 2016
(86) PCT No.: PCT/JP2016/060632

§ 371 Date: Sep. 28, 2017

(30) Foreign Application Priority Data
Mar. 31, 2015 (JP) 2015-072165

(51) Int. Cl. C09J 161/14; C08G 8/10; C08L 61/14; C08K 5/053

(52) U.S. Cl. CPC C09J 161/14; C08K 5/053; C08L 61/14; C08G 8/10

(57) ABSTRACT

The resol type modified phenol resin composition contains a resol type modified phenol resin having a structural unit A by General Formula (1) which is modified by dimethylphenols and a structural unit B represented by General Formula (2). In Formula (1), m representing an integer of 1 or more, wherein in a case where m is 1, R represents a methylol group; in a case where m is 2 or more, R's independently represent a hydrogen atom or a methylol group, and at least one of R's is a methylol group. In Formula (2), n representing an integer of 1 or more, wherein in a case where n is 1, R represents a methylol group; in a case where n is 2 or more, R's independently represent a hydrogen atom or a methylol group, and at least one of R's is a methylol group.

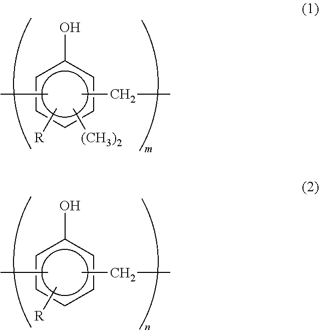

### TECHNICAL FIELD

The present invention relates to a resol type modified phenol resin composition, a method for producing the same, and an adhesive.

### BACKGROUND ART

A resol type phenol resin is a resin material which has excellent mechanical characteristics, electrical characteristics, and adhesiveness. For this reason, the resol type phenol resin is widely used as a binder resin for binding materials as base materials of a molded product in various technical fields. Various studies have been conducted on this resol type phenol resin in the related art in order to improve hardening characteristics such as adhesive strength.

Examples of a technique focusing on the improvement of hardening characteristics of a resol type phenol resin include the following.

In Patent Document 1, there is disclosed an adhesive composition of which the hardening time is short and which has excellent adhesive strength and which contains a resol type phenol resin (A); a polyvinyl butyral resin (B); a polyvalent metal salt (C); and a metal salt of nitrous acid or an ester of nitrous acid (D).

In Patent Document 2, there is disclosed an adhesive for a wet friction plate containing nitrate or nitric acid and a resol type phenol resin which exhibits excellent adhesive strength.

### RELATED DOCUMENT

### Patent Document

[Patent Document 1] Japanese Unexamined Patent Publication No. 2014-24881

[Patent Document 2] Japanese Unexamined Patent Publication No. 2006-83892

### SUMMARY OF THE INVENTION

### Technical Problem

However, in recent years, the technical level required for hardening characteristics of the resol type phenol resin has become higher. Particularly, in recent years, a resol type phenol resin which can achieve excellent adhesive strength within a short hardening time has become necessary from the viewpoint of efficiently manufacturing a molded product having excellent mechanical characteristics within a short period of time.

Here, the present invention provides a resol type modified phenol resin composition which can realize high adhesive strength within a short adhering time, a method for producing the same, and an adhesive containing the resol type modified phenol resin composition.

### Solution to Problem

According to the present invention, there is provided a resol type modified phenol resin composition containing: a resol type modified phenol resin having a structural unit A represented by General Formula (1) which is modified by dimethylphenols and a structural unit B represented by General Formula (2):

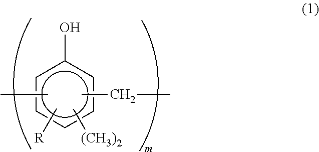

in Formula (1), m representing an integer of 1 or more, wherein in a case where m is 1, R represents a methylol group; in a case where m is 2 or more, R's independently represent a hydrogen atom or a methylol group, and at least one of R's is a methylol group,

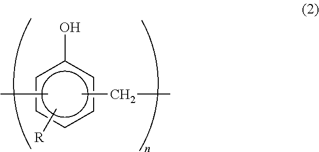

in Formula (2), n representing an integer of 1 or more, wherein in a case where n is 1, R represents a methylol group; in a case where n is 2 or more, R's independently represent a hydrogen atom or a methylol group, and at least one of R's is a methylol group.

Furthermore, according to the present invention, there is provided a method for producing a resol type modified phenol resin composition, the method including a first step of obtaining a first reaction product by reacting aldehydes with phenols excluding dimethylphenols in the presence of a basic catalyst; and a second step of obtaining a resol type modified phenol resin by reacting the first reaction product with the dimethylphenols in the presence of the basic catalyst.

Furthermore, according to the present invention, there is provided an adhesive containing the above-described resol type modified phenol resin composition.

### Advantageous Effects of Invention

According to the present invention, it is possible to provide a resol type modified phenol resin composition which can achieve high adhesive strength within a short adhering time, a method for producing the same, and an adhesive containing the resol type modified phenol resin composition.

### DESCRIPTION OF EMBODIMENTS

### <Resol Type Modified Phenol Resin Composition>

A resol type modified phenol resin composition according to the

present embodiment (hereinafter, also referred to as a resol type phenol resin composition) contains a resol type modified phenol resin having a structural unit A which is modified by dimethylphenols and represented by General Formula (1) and a structural unit B represented by General Formula (2) in its molecular structure. In other words, the resol type modified phenol resin contained in the composition of the present invention has the structural unit A having a dimethylphenol skeleton in a general structure of the resol type phenol resin consisting of the structural unit B. Since this resol type phenol resin composition contains the resol type modified phenol resin containing the structural unit A having two methyl groups as electron-donating groups in this manner, this resol type phenol resin composition has excellent reactivity compared to a resol type phenol resin composition in the related art. In addition, since the resin composition of the present invention contains the resol type modified phenol resin containing the structural unit A having two methyl groups as electron-donating groups as described above, it is also possible to improve the cross-linking density when the resin is thermally hardened. Accordingly, according to the resol type phenol resin composition of the present invention, it is possible to achieve high adhesive strength within a short adhering time compared to the adhesive strength of the resol type phenol resin composition in the related art.

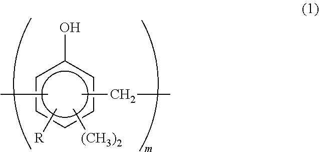

In Formula (1), m representing an integer of 1 or more, wherein in a case where m is 1, R represents a methylol group; in a case where m is 2 or more, R's independently represent a hydrogen atom or a methylol group, and at least one of R's is a methylol group.

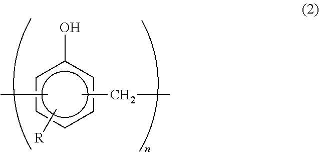

In Formula (2), n representing an integer of 1 or more, wherein in a case where n is 1, R represents a methylol group; in a case where n is 2 or more, R's independently represent a hydrogen atom or a methylol group, and at least one of R's is a methylol group.

The resol type modified phenol resin contained in the above-described resol type modified phenol resin composition is obtained by reacting aldehydes with phenols containing dimethylphenols.

The resol type modified phenol resin of the present invention contains the structural unit A having a dimethylphenol skeleton in addition to the structural unit B which is a general structure provided in the resol type phenol resin. Specific examples of dimethylphenols through which the structural unit A can be derived include 2,3-dimethylphenol, 2,4-dimethylphenol, 2,5-dimethylphenol, 2,6-dimethylphenol, 3,4-dimethylphenol, and 3,5-dimethylphenol. Among these, 3,5-dimethylphenol is preferable from the viewpoint of reactivity of a resin to be obtained, structural stability during heating, or the like in accordance with bulkiness of the methyl groups which are substituent groups. In this case, the resol type modified phenol resin to be obtained has a structural unit C which is modified by 3,5-dimethylphenol and is represented by Formula (3).

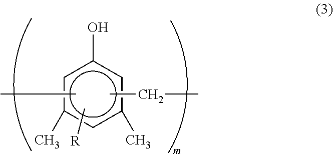

In Formula (3), m representing an integer of 1 or more, wherein in a case where m is 1, R represents a methylol group; in a case where m is 2 or more, R's independently represent at hydrogen atom or a methylol group, and at least one of R's is a methylol group.

In the preferred embodiment, the resol type modified phenol resin of the present invention is composed of the structural unit A and the structural unit B.

Specific examples of phenols through which the structural unit B can be derived include phenol and cresols such as o-cresol, m-cresol, and p-cresol.

In addition, the above-described resol type modified phenol resin may have a structural unit derived from other phenols in addition to the structural unit A derived from dimethylphenols represented by General Formula (1) and the structural unit B derived from phenols represented by Formula (2). Specific examples of the phenols include ethylphenols such as o-ethylphenol, m-ethylphenol, and p-ethylphenol; butylphenols such as isopropylphenol, butylphenol, and p-tert-butylphenol; alkylphenols such as p-tert-amylphenol, p-octylphenol, p-nonylphenol, and p-cumylphenol; halogenated phenols such as fluorophenol, chlorophenol, bromophenol, and iodophenol; monovalent phenol substitution products such as p-phenylphenol, aminophenol, nitrophenol, dinitrophenol, and trinitrophenol; monovalent phenols such as 1-naphthol and 2-naphthol; polyvalent phenols such as resorcin, alkylresorcin, pyrogallol, catechol, alkyl catechol, hydroquinone, alkyl hydroquinone, phloroglucin, bisphenol A, bisphenol F, bisphenol S, and dihydroxynaphthalene. These may be used alone or two or more kinds thereof may be used in combination. Among these, any one or more selected from the group consisting of phenol, cresols, and bisphenol A are preferable from the viewpoint of improving the mechanical strength of a hardened product. In addition, it is preferable that phenols are soluble in an organic solvent to be described below from the viewpoint of handleability in a step of producing a resin.

From the viewpoint of a balance between reactivity during heating, the mechanical strength of a hardened product, production costs of a hardened product, and the like, when the ratio of the structural unit A represented by General Formula (1) in all structural units having a phenolic hydroxyl group contained in the resol type modified phenol resin is set as a dimethylphenol modification rate, the dimethylphenol modification rate of the resol type modified phenol resin composition is preferably greater than or equal to 3% and less than or equal to 50%, more preferably greater than or equal to 3% and less than or equal to 40%, and most preferably greater than or equal to 3% and less than or equal to 35%. By setting the dimethylphenol modification rate to foe greater than or equal to the above-described lower limit value, it is possible to obtain a sufficient effect of improving the hardenability of the resol type modified phenol resin. In addition, by setting the dimethylphenol modification rate to be less than or equal to the above-described upper limit value, it is possible to reduce the amount of expensive dimethylphenols used in the production of the resol type modified phenol resin, and therefore, it is possible to obtain a resol type modified phenol resin which is excellent in practical use from the viewpoint of costs.

Here, this resol type modified phenol resin composition is preferably in a liquid form from the viewpoint of handleability. Hereinafter, an example of the case where this resol type phenol resin composition is in a liquid form will be described.

The resol type modified phenol resin contained in the resin composition of the present invention is obtained by reacting aldehydes with various phenols containing dimethylphenols in the presence of a basic catalyst. Specific examples of the various phenols which are raw materials for producing the resol type modified phenol resin are as described above.

Next, a method for producing this resol type modified phenol resin composition will be described.

A method for producing this resol type modified phenol resin composition includes: a first step of obtaining a first reaction product by reacting aldehydes with phenols excluding dimethylphenols; and a second step of obtaining a resol type modified phenol resin by reacting the first reaction product with the dimethylphenols in the presence of the basic catalyst.

The phenols used in the above-described first step are phenols through which the structural unit B is derived, as described above.

The dimethylphenols used in the above-described second step are dimethylphenols through which the structural unit A is derived, as described above.

Specific examples of aldehydes as raw materials for producing the resol type modified phenol resin include: formaldehyde, paraformaldehyde, trioxane, acetaldehyde, propionaIdehyde, polyoxymethylene, chloral, hexamethylenetetramine, furfural, glyoxal, n-butylaIdehyde, caproaldehyde, allyl aldehyde, benzaldehyde, crotonaldehyde, acrolein, tetraoxymethylene, phenylacetaldehyde, o-tolualdehyde, and salicylaldehyde. These may be used alone or two or more kinds thereof may be used in combination. In addition, it is possible to use precursors of these aldehydes or solutions of these aldehydes. Among these, a formaldehyde aqueous solution is preferably used from the viewpoint of production costs.

Specific examples of the basic catalyst used for producing the resol type modified phenol resin include: hydroxides of alkali metals or alkaline-earth metals such as sodium hydroxide, potassium hydroxide, and calcium hydroxide; carbonates such as sodium carbonate and calcium carbonate; oxides such as lime; sulfites such as sodium sulfite; phosphates such as sodium phosphate; ammonia; and amines such as trimethylamine, triethylamine, monoethanolamine, diethanolamine, triethanolamine, hexamethylenetetramine, and pyridine.

The amount of dimethylphenols used in the above-described second step is, with respect to 100 parts by weight of phenols excluding the dimethylphenols, preferably greater than or equal to 5 parts by weight and less than or equal to 100 parts by weight and more preferably greater than or equal to 5 parts by weight and less than or equal to 50 parts by weight, from the viewpoint of improving reactivity and hardenability of a resol type modified phenol resin to be obtained. By setting the amount of dimethylphenols to be greater than or equal to the above-described lower limit value, it is possible to obtain a sufficient effect of improving hardenability of a resol type modified phenol resin to be obtained. In addition, by setting the amount of dimethylphenols to be less than or equal to the above-described upper limit value, it is possible to reduce the amount of expensive dimethylphenols used, and therefore, it is possible to obtain a resol type modified phenol resin which is excellent in practical use from the viewpoint of costs.

In addition, the value of (F/P), which is expressed in terms of molar ratio, of the total amount (P) of various phenols containing dimethylphenols used in the above-described production method and the amount of aldehydes (F) is preferably greater than or equal to 0.8 and less than or equal to 3 and more preferably greater than or equal to 1 and less than or equal to 2.5, from the viewpoint of improving the adhesive strength of a resol type modified phenol resin to be obtained. By setting the value of (F/P) to be greater than or equal to the above-described lower limit value, it is possible to achieve sufficient cross-linking density when thermally hardening the resol type modified phenol resin, and therefore, it is possible to further improve the adhesive strength. In addition, by setting the value of (F/P) to be less than or equal to the above-described upper limit value, the cross-linking density is prevented from improving to the extent that the adhesiveness thereof is impaired. As a result, it is possible to obtain a resol type modified phenol resin with excellent adhesive strength.

In addition, the amount of basic catalyst used in this production method is, with respect to 1 mole of various phenols containing dimethylphenols, preferably greater than or equal to 0.01 moles and less than or equal to 1 mole and more preferably greater than or equal to 0.05 moles and less than or equal to 0.5 moles, from the viewpoint of reducing the amount of unreacted phenols and unreached aldehydes. By setting the amount of basic catalyst to be greater than or equal to the above-described lower limit value, it is possible to shorten the time required for the synthesis reaction of the resol type modified phenol resin. Therefore, it is possible to achieve a resol type modified phenol resin having excellent productivity. In addition, by setting the amount of basic catalyst to be less than or equal to the above-described upper limit value, it is possible to prevent a rapid increase in the reaction rate of the synthesis reaction of the resol type modified phenol resin itself. Therefore, it is possible to obtain a resin composition with a stable quality.

In addition, the content of unreacted phenols (free phenol) contained in the resol type modified phenol resin is, with respect to the total amount of the resol type modified phenol resin, preferably less than 5 mass % and more preferably less than 3 mass %. By setting the unreacted phenols to be within the above-described range, it is possible to suppress volatilization of phenol components, and therefore, it is possible to provide a favorable working environment. In addition, in a case where the content of the unreacted phenols (free phenol) is less than or equal to the above-described upper limit value, it is unnecessary to perform monomer-removing processing which requires a complicated procedure, when producing this resol type modified phenol resin.

As the reaction solvent used in the above-described first reaction step and second reaction step, water is generally used, but an organic solvent may be used. Specific examples of the organic solvent include alcohols, ketones, and aromatic. Specific examples of the alcohols include methanol, ethanol, propyl alcohol, ethylene glycol, diethylene glycol, triethylene glycol, and glycerin. In addition, specific examples of ketones include acetone and methyl ethyl ketone. Specific examples of aromatics include toluene and xylene.

This resol type modified phenol resin composition preferably contains the above-described resol type modified phenol resin; and one or more elastomers selected from the group consisting of a polyvinyl butyral resin, nitrile butadiene rubber, styrene butadiene rubber, and an epoxy resin. By containing the resin and the elastomer, it is possible to achieve an adhesive with which it is possible to obtain a hardened product having excellent mechanical characteristics such as flexibility and toughness.

The content of the above-described elastomer is, with respect to the total amount of this resol type phenol resin composition, preferably greater than or equal to 1 wt % and less than or equal to 20 wt % and more preferably greater than or equal to 2 wt % and less than or equal to 10 wt %, from the viewpoint of improving the mechanical characteristics of an obtained hardened product. By setting the content of the above-described elastomer to be greater than or equal to the above-described lower limit value, it is possible to improve the flexibility of the resin composition. In a case where the resin composition is used as an adhesive, it is possible to improve the adhesive strength. In addition, by setting the content of the above-described elastomer to be less than or equal to the above-described upper limit value, it is possible to reduce the content of elastomer having inferior heat resistance. Therefore, as a result, it is possible to achieve an excellent resin composition in terms of heat resistance.

In addition, this resol type phenol resin composition may further contain resorcins. This allows the hardening rate of the resol type phenol resin composition to be further improved. Specific examples of the resorcins include resorcin; methyl resorcins such as 2-methyl resorcin, 5-methyl resorcin, and 2,5-dimethyl resorcin; 4-ethyl resorcin; 4-chloro resorcin; 2-nitroresorcin; 4-bromo resorcin; and 4-n-hexyl resorcin. These may be used alone or two or more kinds thereof may be used in combination. Among these, it is preferable to use one or more selected from the group consisting of resorcin, and methyl resorcins from the viewpoint of production costs and moldability of the resin composition.

The content of the above-described resorcins is, with respect to the total amount of this resol type phenol resin composition, preferably greater than or equal to 0.01 wt % and less than or equal to 10 wt % and more preferably greater than or equal to 0.02 wt % and less than or equal to 5 wt %, from the viewpoint of improving hardening characteristics of a hardened product. By setting the content of the above-described resorcins to be greater than or equal to the above-described lower limit value, it is possible to improve hardenability of the resin composition. In addition, by setting the content of the above-described resorcins to be less than or equal to the above-described upper limit value, it is possible to suppress the decrease in cross-linking density. Therefore, it is possible to achieve an excellent resin composition from the viewpoint of hardening characteristics and adhesive strength.

In addition, the resol type phenol resin composition can be provided as a solution in an organic solvent from the viewpoint of improving the handleability thereof. Specific examples of the organic solvent include alcoholic organic solvents such as methanol, ethanol, isopropanol, and butanol; ketone-based organic solvents such as acetone, methyl ethyl ketone, and methyl isobutyl ketone; and aromatic hydrocarbon solvents such as toluene and ethyl benzene.

Next, the use of this resol type phenol resin composition will be described.

It is possible to use this resol type phenol resin composition as an adhesive for bonding a friction material to a base material. Specific examples of the base material include a base material in which fibers such as natural fibers, metal fibers, carbon fibers, and chemical fibers are used alone or two or more kinds thereof are used in combination. Here, examples of such a friction material include a friction material produced by mixing a fiber base material, a filler, and a binding material containing the above-described adhesive and thermoforming the obtained mixture. Specific examples of the above-described fiber base material include inorganic fibers such as steel fibers, copper fibers, glass fibers, ceramic fibers, and potassium titanate fibers; and organic fibers such as aramid fibers and cellulose fibers. These may be used alone or two or more kinds thereof may be used in combination. Among these, it is preferable to include organic fibers such as aramid fibers. Specific examples of the above-described filler include inorganic fillers such as diatomaceous earth, calcium carbonate, calcium hydroxide, barium sulfate, mica, abrasive, kaolin, and talc; organic fillers such as cashew dust and rubber dust; and lubricating materials such as graphite, antimony trisulfide, molybdenum disulfide, and zinc disulfide. These may be used alone or two or more kinds thereof may be used in combination. Among these, it is preferable to use inorganic fillers.

This resol type phenol resin composition can also be used as a production raw material for producing molded products such as a grinding wheel, a casting, a rubber molded product, adhesive tape, felt, a mold material, a refractory material, and a heat insulating material. In this case, a filler may be appropriately added to and mixed with this resol type phenol resin composition in accordance with the use of the molded product. In addition, in the case where this resol type phenol resin composition is used in the above-described application, it is possible to obtain each molded product by heating and kneading this resol type phenol resin composition and molding this resol type phenol resin composition into a desired shape. The above-described heating and kneading may be performed using a kneader alone such as a roll, a co-kneader, or a twin screw extruder, or may be performed using a combination of a roll and another kneader.

In a case where this resol type phenol resin composition is in a powder form, the resol type phenol resin composition can foe used in applications shown in the following (1) to (13). In this case, it is preferable to add fillers such as abrasive grains, an inorganic filler, an organic filler, silica sand, a hardening agent, a coupling agent, rubber, a base material, solvent, pigment, fiber, a surfactant, a coagulant, a hair material, a foaming agent, glass, aggregate, carbon, and acids to this resol type phenol resin composition through dry mixing, before use. Here, dry mixing refers to mixing this powdery resol type phenol resin composition and a filler with each other without melting them. When subjecting this resol type phenol resin composition and the filler to dry mixing, the components thereof may be heated. However, an embodiment such as heating and kneading in which either of the resol type phenol resin composition or the filler is melted and kneaded is not used.

(1) A resin material for obtaining grinding wheels such as a usual grinding wheel, a heavy grinding wheel, a cut-off grinding wheel, an offset grinding wheel, and a diamond grinding wheel for glass cloth processing.

(2) A resin material for obtaining abrasive cloth and paper such as abrasive cloth, abrasive paper, disc sandpaper, and abrasive buff.

(3) A resin material for obtaining castings such as: a material used for a shell molding method (cold coating, semi-hot coating, and dry hot coating); organic self-hardening materials (a cold box, phenol urethane, phenolic acid hardened material, Lino-cure, Furan, an organic acid ester); a hot box; a shell adhesive; and a coating material.

(4) A resin material for obtaining friction materials such as a brake lining, a clutch facing, a disc pad, a paper clutch facing, and a brake block.

(5) A resin material for obtaining rubber such as a rubber reinforcing material, a hot melt adhesive, adhesive tape, a rubber type adhesive formulation, rubber latex formulation, a tackifier, a pressure sensitive adhesive, a metal adhesive formulation, rubber vulcanizate, and a sealing material.

(6) A resin material for obtaining electrical insulating materials such as a capacitor coating material and insulating varnish.

(7) A resin material for obtaining coating materials or printing ink such as a base for coating material, an oil-modified coating material, a coating material for furniture, a coating material for metallic can, printing ink for offset printing, a dyeing auxiliary, and a photoresist.

(8) A resin material for obtaining organic materials such as felt, phenolic foam, a wood powder molding material, phenol resin fiber, hardboard, particle board, reinforced wood, and insulation board.

(9) A resin material for obtaining pulp-impregnated products such as beater addition material, a battery separator, an air filter, and oil filter.

(10) A resin material for obtaining inorganic fiber-binding products such as a glass fiber product (mat or heat insulation cylinder), rock wool/slag wool products, and a fishing rod.

(11) A resin material for obtaining refractory products such as amorphous materials (a mud material, a spray material, a stamp material, throwing-in material, press-in material, and castable), shaped material (basic unbaked material, baked silicon carbide material, a sliding nozzle, and an immersion nozzle), a riser heat insulation material, tundish board, aggregate primary binding material, and a crucible.

(12) A resin material for obtaining woodworking adhesives such as plywood (special kind), laminated lumber, and panel adhesive.

(13) A resin material for obtaining other products such as a non-permeable carbon product, a carbonaceous sealing material, electric brush, a sliding material, activated carbon, corrosion resistant joint agent, epoxy resin hardening agent, casting, and phenol FRP.

Hereinabove, the embodiment of the present invention has been described. However, the embodiment is an example of the present invention and it is possible to employ various configurations other than the above-described configurations.

### EXAMPLES

Hereinafter, the present invention will foe described using Examples and Comparative Example, but is not limited thereto.

### Example 1

100 parts by weight of phenol, 117 parts by weight (F/P molar ratio=1.2) of 37% formalin aqueous solution, and 4 parts by weight of 30% ammonia aqueous solution were added to a reaction apparatus provided with a mixing device, a reflux condenser, and a thermometer, and were reacted for 40 minutes under a reflux condition. Thereafter, parts by weight of methanol and 15 parts by weight of 3,5-dimethylphenol were added thereto when the temperature of the system reached 70° C. while performing dehydration under a reduced pressure condition of 91 kPa, and were reacted for 3 hours at 80° C. Next, a resol type modified phenol resin was obtained by adding 7 parts by weight of methanol and 15 parts by weight of toluene. The obtained resol type modified phenol resin had a structural unit derived from 3,5-dimethylphenol and a structural unit derived from phenol, in a molecular structure.

391 parts by weight of an adhesive (resol type modified phenol resin composition) was obtained by mixing the obtained resol type modified phenol resin in a solution which was obtained by dissolving 29 parts by weight of polyvinyl butyral resin in 78 parts by weight of methanol and 6 parts by weight of toluene.

### Example 2

The same method as that in Example 1 was employed except that an adhesive (resol type modified phenol resin composition) was obtained by adding 3 parts by weight of resorcin to the adhesive (resol type modified phenol resin composition) of Example 1.

### Example 3

A resol type modified phenol resin and an adhesive (resol type modified phenol resin composition) were produced through the same method as in Example 1 except that 5 parts by weight of 3,5-dimethylphenol was used. The obtained resol type modified phenol resin had a structural unit derived from 3,5-dimethylphenol and a structural unit derived from phenol, in a molecular structure.

### Example 4

A resol type modified phenol resin and an adhesive (resol type modified phenol resin composition) were produced through the same method as in Example 1 except that 50 parts by weight of 3,5-dimethylphenol was used. The obtained resol type modified phenol resin had a structural unit derived from 3,5-dimethylphenol and a structural unit derived from phenol, in a molecular structure.

### Comparative Example 1

A resol type phenol resin and an adhesive (resol type phenol resin composition) were produced through the same method as in Example 1 except that 3,5-dimethylphenol was not used. The obtained resol type phenol resin had a structural unit derived from phenol, but did not have a structural unit derived from 3,5-dimethylphenol, in a molecular structure.

The following evaluation was performed using the adhesives in Examples and Comparative Example. It was confirmed that almost ail of the 3,5-dimethylphenols which was used for the production of the resol type modified phenol resins in Examples were reacted. For this reason, the dimethylphenol modification rate was calculated through a method to be described below.
Adhesive strength: After coating two sheets of pickled steel plates with an adhesive in Examples or Comparative. Example, drying processing was performed for 15 minutes at 80° C. Next, a test piece was produced by performing thermo-compression bonding for 30 minutes at 160° C. under a pressure condition of 5 MPa. A tensile shear test was performed using the obtained test piece according to JIS K6850, and the adhesive strength was measured. The unit is in MPa.
Hardenability: 2.5 mL of an adhesive in Examples or Comparative Example was added dropwise to a dice which was heated at 165° C., and the curelast torque was measured by making the adhesive gelate, while performing visual observation. Thereafter, the hardenability of the adhesive was evaluated by setting a 90% torque arrival time as a hardening completion time. The unit is in minutes.
Dimethylphenol modification rate: A value which was obtained by multiplying a value, which was obtained by dividing the number of parts by weight of 3,5-dimethylphenol used in the production of a resol type modified phenol resin by the total value of number of parts by weight of 3,5-dimethylphenol and phenol, by 100 was calculated as a dimethylphenol modification rate. The unit is in %.

The evaluation results relating to the above-described evaluation categories are shown in Table 1 below together with the blended compositions of the resol type modified phenol resins and the adhesives.

TABLE 1

| | | | | | | Comparative |
|---|---|---|---|---|---|---|
| | | Example 1 | Example 2 | Example 3 | Example 4 | Example 1 |
| Resol | Phenol | 100 | 100 | 100 | 100 | 100 |
| type | 37% formalin | 117 | 117 | 117 | 117 | 117 |
| modified | aqueous solution | | | | | |
| phenol | 30% ammonia | 4 | 4 | 4 | 4 | 4 |
| resin | aqueous solution | | | | | |
| [parts | Methanol | 27 | 27 | 27 | 27 | 27 |
| by | 3,5-Dimethylphenol | 15 | 15 | 5 | 50 | — |
| weight] | Toluens | 15 | 15 | 15 | 15 | 15 |
| | Total | 278 | 278 | 268 | 313 | 263 |
| Adhesive | Resol type modified | 278 | 278 | 268 | 313 | 263 |
| [parts | phenol resin | | | | | |
| by | Polyvinyl | 29 | 29 | 29 | 29 | 29 |
| weight] | butyral resin | | | | | |
| | Methanol | 78 | 78 | 78 | 78 | 78 |
| | Toluene | 6 | 6 | 6 | 6 | 6 |
| | Resorcin | — | 3 | — | — | — |
| | Total | 391 | 394 | 381 | 426 | 376 |

| | | | | | |
|---|---|---|---|---|---|
| Dimethylphenol modification rate [%] | 13 | 13 | 4.8 | 33 | — |
| Adhesive strength [MPa] | 23 | 25 | 23 | 22 | 23 |
| Hardenability [Minute] | 5.9 | 5.0 | 7.0 | 5.5 | 9.2 |

The adhesives in Examples can achieve high adhesive strength within a short adhering time compared to the adhesive in Comparative Example 1.

Priority is claimed on Japanese Patent Application No. 2015-72165, filed Mar. 31, 2015, the whole disclosure of which is incorporated herein by reference.

1. A resol type modified phenol resin composition comprising:
a resol type modified phenol resin having a structural unit A represented by General Formula (1) which is modified by dimethylphenols and a structural unit B represented by General Formula (2); 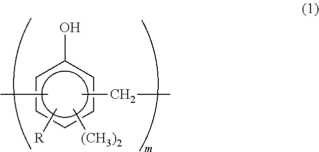
in Formula (1), m representing an integer of 1 or more, wherein in a case where m is 1, R represents a methylol group; in a case where m is 2 or more, R's independently represent a hydrogen atom or a methylol group, and at least one of R's is a methylol group, 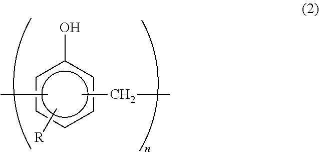
in Formula (2), n representing an integer of 1 or more, wherein in a case where n is 1, R represents a methylol group; in a case where n is 2 or more, R's independently represent a hydrogen atom or a methylol group, and at least one of R's is a methylol group.

2. The resol type modified phenol resin composition according to claim 1,
wherein the dimethylphenols are 3,5-dimethylphenol.

3. The resol type modified phenol resin composition according to claim 1,
wherein when the ratio of the structural unit A with respect to the total of structural units having a phenolic hydroxyl group contained in the resol type modified phenol resin is set as a dimethylphenol modification rate, the dimethylphenol modification rate is greater than or equal to 3% and less than or equal to 50%.

4. The resol type modified phenol resin composition according to claim 1, further comprising one or more elastomers selected from the group consisting of a polyvinyl butyral resin, nitrile butadiene rubber, styrene butadiene rubber, and an epoxy resin.

5. The resol type modified phenol resin composition according to claim 1, further comprising resorcins.

6. A method for producing a resol type modified phenol resin composition, the method comprising:
a first step of obtaining a first reaction product by reacting aldehydes with phenols excluding dimethylphenols in the presence of a basic catalyst; and
a second step of obtaining a resol type modified phenol resin by reacting the first reaction product with the dimethylphenols in the presence of the basic catalyst.

7. The method for producing a resol type modified phenol resin composition according to claim 6,
wherein the amount of the dimethylphenols reacted in the second step is greater than or equal to 5 parts by weight and less than or equal to 100 parts by weight with respect to 100 parts by weight of phenols excluding the dimethylphenols.

8. An adhesive comprising the resol type modified phenol resin composition according to claim 1.
